(19) United States
(12) Patent Application Publication
(10) Pub. No.: US 2025/0323730 A1
(43) Pub. Date: Oct. 16, 2025

(54) SYSTEM AND METHOD FOR GENERATING OPTICAL FREQUENCY COMB-BASED SIGNAL FOR RADIO TELESCOPE

(71) Applicants: KOREA ADVANCED INSTITUTE OF SCIENCE AND TECHNOLOGY, Daejeon (KR); KOREA RESEARCH INSTITUTE OF STANDARDS AND SCIENCE, Daejeon (KR); KOREA ASTRONOMY OBSERVATORY, Daejeon (KR)

(72) Inventors: Jungwon KIM, Daejeon (KR); Minji HYUN, Daejeon (KR); Changmin AHN, Daejeon (KR); Myoung-Sun HEO, Daejeon (KR); Taehyun JUNG, Daejeon (KR); Doheung JE, Daejeon (KR)

(21) Appl. No.: 19/170,173

(22) Filed: Apr. 4, 2025

(30) Foreign Application Priority Data
Apr. 16, 2024 (KR) 10-2024-0050794

(51) Int. Cl. H04B 10/50; G02F 1/35; H04B 10/2575

(52) U.S. Cl. CPC H04B 10/503; G02F 1/353; H04B 10/2575; G02F 2203/56

(57) ABSTRACT

An optical frequency comb-based signal generating system for a radio telescope includes: a laser configured to output an optical frequency comb synchronized with a frequency reference; an optical fiber link configured to transmit the optical frequency comb to a receiving end of a radio telescope; a fiber link stabilizer configured to detect a timing difference between an optical pulse reflected from the receiving end and an optical pulse output from the laser, and adjust a length of the optical fiber link based on the timing difference to compensate optical fiber link noise; and a signal generator configured to generate at least one signal used by the radio telescope through photodetection of an optical frequency comb received at the receiving end.

### CROSS-REFERENCE TO RELATED APPLICATION

This application claims priority to and the benefit of Korean Patent Application No. 10-2024-0050794 filed with the Korean Intellectual Property Office on Apr. 16, 2024, the entire contents of which are incorporated herein by reference.

### BACKGROUND

### (a) Field

The present disclosure relates to optical frequency combs.

### (b) Description of the Related Art

Very long baseline interferometer (VLBI) is an observation technique for significantly improving the resolution using a very large virtual antenna by simultaneously measuring the same signal at multiple distant radio telescopes. The VLBI is not only used to perform precise observations with very high resolution in the field of astronomy, but is also very important in geodesy, such as precisely determining the position of space probes. With the recent rapid development of optical clocks, discussions on redefining of the second as a time unit have emerged. In this context, VLBI is being explored for intercontinental optical clock comparison. Recent developments in high-precision antennas and radio frequency receivers have driven research into expanding radio frequency VLBI ranging from tens of GHz to hundreds of GHz.

The VLBI measures a time delay of radio frequency (RF) signals reaching at least two antennas. To this end, the VLBI down-converts the RF signals received from the radio telescope (or antenna) using a local oscillator (LO), records resultant signals, and obtains a time delay from the recorded signals through a cross-correlator. Therefore, a very stable local oscillator is required for precise measurement. The time delay contains not only geometric delay but also other contributions such as a time difference (or frequency stability difference) of an atomic clock used at each antenna, an atmospheric influence, and an internal instrumental phase difference used for observation. Therefore, these influences must be well calibrated for high precision time delay measurement.

### SUMMARY

The present disclosure attempts to provide a system and method for generating optical frequency comb-based signals for a radio telescope.

Some embodiments of the present disclosure provide a system including: a laser configured to output an optical frequency comb synchronized with a frequency reference; an optical fiber link configured to transmit the optical frequency comb to a receiving end of a radio telescope; a fiber link stabilizer configured to detect a timing difference between an optical pulse reflected from the receiving end and an optical pulse output from the laser, and adjust a length of the optical fiber link based on the timing difference to compensate optical fiber link noise; and a signal generator configured to generate at least one signal used by the radio telescope through photodetection of an optical frequency comb received at the receiving end.

The signal generator may be configured to: generate a photocurrent pulse train through photodetection of the received optical frequency comb; and generate a microwave signal for a local oscillator by filtering a single frequency component of the photocurrent pulse train.

The signal generator may be configured to: generate a photocurrent pulse train through photodetection of the received optical frequency comb; and output the photocurrent pulse train, corresponding to a radio-frequency (RF) comb, as a signal for phase calibration between channel devices of a multi-band receiver.

An optical pulse train output from the laser may be divided into a first stream and a second stream. The first stream may be input to the fiber link stabilizer and be used as a reference signal for detecting noise information of the optical fiber link. The second stream may be transmitted to the radio telescope through the optical fiber link.

The fiber link stabilizer may be configured to transmit information on the timing difference to a fiber length adjuster disposed on the optical fiber link to compensate the timing difference.

The fiber link stabilizer may be configured to: generate a photocurrent pulse through photodetection of the reflected optical pulse and detect the timing difference between the optical pulse output from the laser and the photocurrent pulse; or generate a microwave signal from the photocurrent pulse and detect the timing difference between the optical pulse output from the laser and the microwave signal.

The frequency reference may include an atomic clock. The laser may be configured to be synchronized with the frequency reference disposed on a local site, or be synchronized with the frequency reference disposed on a remote site by receiving a signal from the remote site.

Some embodiments of the present disclosure provide a method for generating signals for a radio telescope by a system including: outputting an optical frequency comb synchronized with a frequency reference, through a laser; obtaining an optical pulse reflected from a receiving end of the radio telescope through an optical fiber link, the optical fiber link configured to transmit the optical frequency comb to the receiving end from a transmitting end; detecting a timing difference between an optical pulse reflected from the receiving end and an optical pulse output from the laser; adjusting a length of the optical fiber link based on the timing difference to compensate optical fiber link noise; and generating at least one signal used by the radio telescope through photodetection of the optical frequency comb received at the receiving end.

The generating the at least one signal may include: generating a photocurrent pulse train through photodetection of the received optical frequency comb; and generating a microwave signal for a local oscillator by filtering a single frequency component of the photocurrent pulse train.

The generating the at least one signal may include: generating a photocurrent pulse train through photodetection of the received optical frequency comb; and outputting the photocurrent pulse train, corresponding to a radio-frequency (RF) comb, as a signal for phase calibration between channel devices of a multi-band receiver.

An optical pulse train output from the laser may be divided into a first stream and a second stream. The first stream may be input to the fiber link stabilizer and be used as a reference signal for detecting noise information of the optical fiber link. The second stream may be transmitted to the radio telescope through the optical fiber link.

The adjusting the length of the optical fiber link may include transmitting information on the timing difference to a fiber length adjuster disposed on the optical fiber link to compensate the timing difference.

The detecting the timing difference may include: generating a photocurrent pulse through photodetection of the reflected optical pulse, and detecting the timing difference between the optical pulse output from the laser and the photocurrent pulse; or generating a microwave signal from the photocurrent pulse, and detecting the timing difference between the optical pulse output from the laser and the microwave signal.

The frequency reference may include an atomic clock. The laser may be configured to be synchronized with the frequency reference disposed on a local site, or be synchronized with the frequency reference disposed on a remote site by receiving a signal from the remote site.

Some embodiments of the present disclosure provide a system including: a laser configured to output an optical pulse train synchronized with a frequency reference; an optical fiber link configured to transmit a first optical pulse train to a receiving end of a radio telescope, the first optical pulse train being divided from the optical pulse train output from the laser; a fiber length adjuster configured to adjust a length of the optical fiber link according to an input, disposed on the optical fiber link; a fiber link stabilizer configured to detect a timing difference between a second optical pulse train and an optical pulse train reflected from the receiving end, and compensate optical fiber link noise of the first optical pulse train by transmitting information on the timing difference to the fiber length adjuster, the second optical pulse train being divided from the optical pulse train output from the laser; and a signal generator configured to generate at least one signal used by the radio telescope through photodetection of the first optical pulse train at the receiving end.

The signal generator may include: a photodetector configured to generate a photocurrent pulse train through photoelectric conversion of the first optical pulse train, and a band pass filter configured to output a microwave signal by filtering a single frequency component of the photocurrent pulse train, and wherein the microwave signal is used as a signal for a local oscillator.

The signal generator may include a photodetector configured to generate a photocurrent pulse train through photoelectric conversion of the first optical pulse train. The photocurrent pulse train, corresponding to a radio-frequency (RF) comb, may be used as a signal for phase calibrating between channel devices of a multi-band receiver.

The fiber link stabilizer may include: a photodetector configured to output a photocurrent pulse train through photoelectric conversion of the reflected optical pulse train; and an electro-optic sampling-based timing detector (EOS-TD) configured to detect the timing difference between the second optical pulse train and the photocurrent pulse train.

The fiber link stabilizer may be configured to: generate a photocurrent pulse through photodetection of the reflected optical pulse; generate a microwave signal from the photocurrent pulse through a band pass filter; and detect the timing difference between the second optical pulse train and the microwave signal through an electro-optic sampling-based timing detector (EOS-TD).

The laser may be configured to output an optical frequency comb following stability of the frequency reference by being synchronized with the frequency reference disposed on a local site, or being synchronized with the frequency reference disposed on a remote site by receiving a signal from the remote site.

According to the embodiment, the optical frequency comb for connecting the optical frequency domain and the microwave frequency domain may be directly transmitted to the remote radio telescope, and by using this, the low-noise local oscillator signal and the instrumental phase calibration signal required for observation may be easily generated.

According to the embodiment, the stability of the atomic clock may be transferred remotely using the optical frequency comb, allowing the very long baseline interferometer (VLBI) to fully utilize the stability of the atomic clock.

According to the embodiment, high correlation efficiency may be achieved by using the stabilized system to the atomic clock, enabling the high sensitivity radio interferometer observations minimizing the loss in the radio frequency bandwidth.

According to the embodiment, instrumental phase calibration signals in the tens of GHz band, which were challenging to generate with conventional electronic technology, can be provided using photon technology, maximizing the effect of atmospheric phase calibration through multi-channel simultaneous observation.

According to the embodiment, it is possible to calculate high-precision time delay from the VLBI based on the radio frequency bandwidth of several tens GHz and the wideband of up to 100 GHz, thereby improving the precision of the international celestial reference frame (ICRF), the international terrestrial reference frame (ITRF), and the earth orientation parameter (EOP), which have been implemented in the existing low frequency bandwidth of 10 GHz or less, and it may also contribute to improving determination of the precise position of the deep space probe and the navigation precision using the delta differential one-way ranging (ΔDOR) technology.

### BRIEF DESCRIPTION OF THE DRAWINGS

FIG. 1 shows a schematic diagram on a system for generating signals for a radio telescope according to an embodiment.

FIG. 2 shows a configuration of a transmitting end of a signal generating system for a radio telescope according to an embodiment.

FIG. 3 shows a configuration of a fiber link stabilizer according to an embodiment.

FIG. 4 shows a configuration of a signal generator according to an embodiment.

FIG. 5 shows an example of a generated instrumental phase calibration signal according to an embodiment.

FIG. 6 conceptually shows generation of an optical frequency comb-based signal for a radio telescope according to an embodiment.

FIG. 7 shows an example of a timing detector according to an embodiment.

FIG. 8 shows a flowchart on a method for generating signals for a radio telescope according to an embodiment.

### DETAILED DESCRIPTION OF THE EMBODIMENTS

In the following detailed description, only certain embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive, and like reference numerals designate like elements throughout the specification.

Unless explicitly described to the contrary, the word “comprise”, and variations such as “comprises” or “comprising”, will be understood to imply the inclusion of stated elements but not the exclusion of any other elements.

In the description, reference numerals and names are arbitrarily shown for understanding and ease of description, but the present disclosure is not limited thereto.

The very long baseline interferometer (VLBI) down-converts an RF signal received from a radio telescope antenna using a local oscillator (LO), and obtains a time delay from the down-converted signal through a cross-correlator.

For precise measurement, a very stable local oscillator following stability of a reference frequency is required. The most widely used atomic clock for the VLBI today is a hydrogen maser (H-maser), which has the frequency stability of 10⁻¹³ per second and 10⁻¹⁵ per thousand seconds. However, the hydrogen maser has an output frequency in the MHz range (5 MHz), while the microwave signal frequency used in the local oscillator reaches several tens of GHz, so generation of a high-frequency microwave signal from the hydrogen maser requires a complex multiplication chain that multiplies the frequency in multiple steps, which inevitably deteriorates noise performance of the signal.

Meanwhile, higher frequency VLBI observations may achieve higher angular resolution, but it becomes more difficult to calibrate tropospheric effects to maintain phase coherence of the radio signal received at the antenna. Multi-channel simultaneous observations may be used as a solution to calibrate the phase delay that occurs as radio signals pass through the rapidly changing Earth's atmosphere. However, when performing multi-channel simultaneous observations, phase delays between channel devices are inevitably generated. Therefore, for high-precision time delay measurement, atmospheric phase calibration must be performed through multi-channel simultaneous observation, and instrumental phase calibration inevitably occurring during the multi-channel simultaneous observation must be performed.

Photonic technology is being researched as a technology for the VLBI due to its excellent timing performance of optical clocks and its great advantages in long-distance transmission. However, despite the stable long-distance optical fiber transmission of hundreds to thousands of kilometers and the excellent timing jitter performance of the optical frequency combs, there are limitations that prevent the full benefits of photonic technology from being used due to the absence of the last-mile technology from the observatory to the antenna.

The present disclosure details how these limitations may be addressed. According to the present disclosure, the optical frequency comb synchronized to a frequency reference such as an atomic clock may be directly transmitted to at least one remote receiving end (or a radio telescope antenna) from a transmitting end (or an observatory), and may be implemented to generate various signals required by the radio telescope at the receiving end, such as a microwave signal for a local oscillator and an instrumental phase calibration signal for a multi-channel receiver.

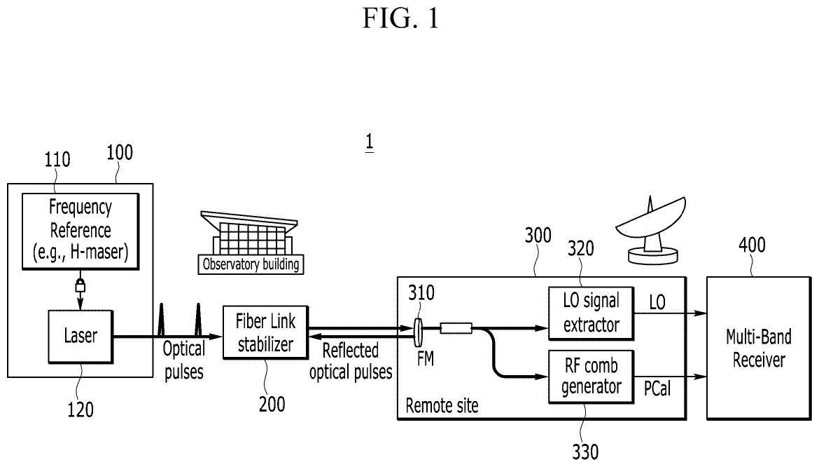

FIG. 1 shows a schematic diagram on a system for generating signals for a radio telescope according to an embodiment.

Referring to FIG. 1, the system 1 for generating signals for a radio telescope may be configured to transmit the optical frequency comb following the stability of frequency reference such as an atomic clock to the antenna of the very long baseline interferometer (VLBI) and generate signals for measurement of the radio telescope. The signals needed by the radio telescope may include local oscillator (LO) signal stabilized for the frequency reference, and an instrumental phase calibration (simply, PCal) signal for solving a phase delay generated between channel devices in the multi-band receiver 400. The system 1 may include an optical frequency comb synchronizer 100, a fiber link stabilizer 200, and a signal generator 300. The optical frequency comb synchronizer 100 and the fiber link stabilizer 200 may be arranged in the observatory, and the signal generator 300 may be arranged at the antenna that is distant from the observatory. The optical frequency comb synchronizer 100 may include a frequency reference 110, and a laser 120 for outputting an optical frequency comb following stability of the frequency reference 110. To transmit stability of the frequency reference 110 to the optical frequency comb, the optical frequency comb synchronizer 100 may further include a timing detector (TD) (not shown) for detecting a timing difference (or phase difference) between the frequency reference 110 and the laser 120, and the timing difference (or timing error) detected by the timing detector may be compensated by a driver of the optical frequency comb. The driver of the optical frequency comb may be realized as lead zirconate titanate (PZT) or an electronic-optical modulator.

The frequency reference 110 may be an atomic clock. The atomic clock may include an optical clock or a microwave clock. For example, the hydrogen maser (H-maser) may be used as the frequency reference. The frequency reference 110 may be disposed on a local site (e.g., an observatory), or may be disposed on a remote site that is distant from the observatory. For better understanding and ease of description, the frequency reference 110 is described to be disposed on a local place, but is not limited thereto.

The laser 120 may output an optical pulse train following stability of the frequency reference. The laser 120 may be mode-locked laser for providing excellent time resolution with a very short pulse width and a low timing jitter. Optical pulses output by the laser 120 may be directly transmitted to the remote signal generator 300 through an optical fiber link. The laser 120 may be synchronized with the local frequency reference 110. In another way, the laser 120 may be implemented to receive signals of the remote frequency reference and be synchronized.

The fiber link stabilizer 200 may calibrate residual timing jitter generated while directly transmitting optical frequency combs to the remote signal generator 300 from the laser 120 through an optical fiber link. In general, the antenna is installed in a place with bad environmental conditions so the signal source such as the hydrogen maser is disposed in an additional building. Therefore, the residual timing jitters are generated when directly transmitting the optical frequency comb to the antenna through the optical fiber link, so the stability of the frequency reference may be transmitted to the antenna when the residual timing jitters are calibrated.

The fiber link stabilizer 200 may obtain the partly reflected optical pulse through a Faraday mirror (FM) 310 disposed at a receiving end of the optical fiber link, may compare a timing difference with a reference optical pulse, and may detect the residual timing jitters generated by the optical fiber link. The fiber link stabilizer 200 may directly compensate the residual timing jitters caused by the optical fiber link, through a fiber length adjuster. The fiber length adjuster may be implemented in many ways like an actuator for adjusting lengths of optical fibers. A fiber stretcher (FS) will now be described as an example of the fiber length adjuster, but is not limited thereto.

Relative timing detection between the reflected optical pulse and the reference optical pulse may be performed by various methods. For example, it may be performed in an optical-optical signal region by an optical cross-correlator (OC) or by an electro-optic sampling-based timing detector (EOS-TD). The EOS-TD may photoelectrically convert the optical pulse reflected by a high-speed photodetector (PD) and may use a resultant signal. The photoelectrically converted signal may be a photocurrent pulse or a microwave signal with a single frequency.

The signal generator 300 may receive the optical frequency comb for transmitting stability of the frequency reference (e.g., a hydrogen clock) through the optical fiber link, and may generate RF signals for the radio telescope from the optical frequency comb, that is, microwave signals (or LO signals) input to the local oscillator for performing radio signal down-conversion and instrumental phase calibration signals (or PCal signals).

The signal generator 300 may detect the optical pulse train transmitted through the optical fiber link by using the high-speed photodetector (PD), and may generate a low-noise photocurrent pulse train that corresponds to the RF comb to the bandwidth of the photodetector. The signal generator 300 may use the photocurrent pulse train as the instrumental phase calibration signal (or PCal signal) of the radio telescope by using the characteristic that the photocurrent pulse train is equal to the wideband RF comb including components that correspond to an integer multiple of a repetition rate in a frequency domain.

The LO signal extractor 320 may filter out a single frequency component from among integer multiple components with a repetition rate detected through the high-speed photodetector (PD) through a band pass filter (BPF) to amplify the same, and may generate a microwave signal in a GHz band, and may output the microwave signal as a LO signal of the radio telescope. To alleviate saturation of the photodetector (PD) caused by the low repetition rate, the LO signal extractor 320 may further include an optical fiber-based repetition rate multiplier.

The RF comb generator 330 may output the RF comb detected through the high-speed photodetector (PD) as the instrumental phase calibration signal (or PCal signal).

The signal generator 300 may directly receive the optical frequency comb following the stability of the frequency reference through the optical fiber link to generate a wideband RF comb, and may selectively extract the needed single frequency component to generate a microwave signal for the local oscillator.

The hydrogen maser generally used to the VLBI has a MHz-leveled output frequency (5 MHz), and the microwave signal frequency used by the local oscillator has several tens of GHz. Therefore, to generate the RF microwave signal from the hydrogen maser, a frequency multiplying process with multiple stages through a complicated multiplication chain may be performed, thereby deteriorating the noise performance of the signal. On the contrary, the signal generator 300 extracts the microwave signal from the optical frequency comb using a frequency dividing process, thereby providing excellent noise performance. The optical frequency comb may also directly transmit excellent stability of the optical frequency domain to the receiving end, thereby providing potential that directly uses stability of the optical frequency domain such as an atomic clock.

To calibrate the phase between channel devices of the multi-band receiver 400, it is needed to obtain relative phase information between channels through the RF comb signal including a multi-channel observing region. The repetition rate of the frequency comb is several tens to several hundreds of MHz, and an observation channel is disposed at several tens of GHz so a very wide RF comb is needed to calibrate the instrumental phase. However, the existing system has a technical difficulty in generating signals of equal to or greater than 50 GHz because of big loss. However, the signal generator 300 according to the present disclosure may directly receive the wideband optical frequency comb through the optical fiber link, thereby easily obtaining the wideband RF comb. The repetition rate of the optical frequency comb may be in the range of several MHz to several hundred MHz, and a bandwidth of the high-speed photodetector for controlling the range of the RF comb may be several hundred GHz to the maximum. Therefore, the signal generator 300 may easily generate the instrumental phase calibration signal that is difficult to be generated by the existing system.

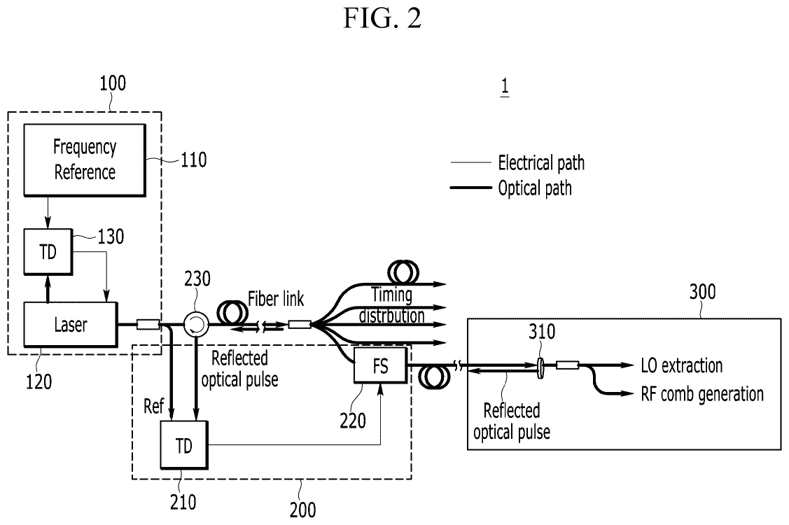

FIG. 2 shows a configuration of a transmitting end of a signal generating system for a radio telescope according to an embodiment.

Referring to FIG. 2, the signal generating system 1 for a radio telescope may transmit stability of the frequency reference 110 to the remote radio telescope through the optical frequency comb output by the laser 120, and may generate a microwave signal used as a LO signal and a RF comb used in instrumental phase calibration from the optical frequency comb in the radio telescope.

The optical frequency comb synchronizer 100 and the fiber link stabilizer 200 configuring the system 1 may be connected to the signal generator 300 through the optical fiber link.

The optical frequency comb synchronizer 100 may include a frequency reference 110 such as a hydrogen maser (H-maser), a laser 120 for outputting optical frequency combs, and a timing detector (TD) 130 for detecting a timing difference (or a phase difference) between the frequency reference 110 and the laser 120 and transmitting the same to the laser 120. The laser 120 may compensate the timing difference with the frequency reference 110 detected by the timing detector 130 and may generate an optical frequency comb. By this, the laser 120 may be synchronized with the frequency reference 110 and may output the optical frequency comb following the stability of the frequency reference 110. The optical frequency comb providing the stability of the hydrogen maser may be directly transmitted to the radio telescope through the optical fiber link.

The fiber link stabilizer 200 may calibrate the residual timing jitters generated while directly transmitting the optical frequency comb through the optical fiber link by the timing detector 210 for detecting noise in the optical fiber link and a fiber length adjuster implemented in the optical fiber link, for example, the fiber stretcher (FS) 220.

The optical pulse train output by the laser 120 is divided into two streams, and one stream may be used as a reference signal of the timing detector 210, and the other stream may pass through a circulator 230 and may be transmitted to the radio telescope through the optical fiber link. The optical pulse transmitted to the timing detector 210 may be referred to as a reference optical pulse, and the optical pulse transmitted to the radio telescope may be referred to as a target optical pulse. Here, the optical pulse may be divided by a wavelength division multiplexer (WDM) and may be transmitted to the radio telescopes.

A portion of a target optical pulse transmitted to the radio telescope through the optical fiber link may be reflected from the Faraday mirror (FM) 310 disposed at an end of the optical fiber link and may return through the optical fiber link. The reflected optical pulse may be transmitted to the timing detector 210 by the circulator 230.

The timing detector 210 may detect a timing difference between the reflected optical pulse and the reference optical pulse, and may provide optical fiber link noise detected as the timing difference to the fiber stretcher (FS) 220 for adjusting lengths of optical fibers as a feedback. The fiber stretcher (FS) 220 may adjust the length of the optical fiber link according to optical fiber link noise information and may calibrate the noise caused by the optical fiber link. The timing detector 210 may output a voltage that corresponds to the timing difference between the reflected optical pulse and the reference optical pulse. The timing detector 210 may detect the timing difference in the optical-optical signal region through the optical cross-correlator (OC), or may detect the timing difference through the electro-optic sampling-based timing detector (EOS-TD).

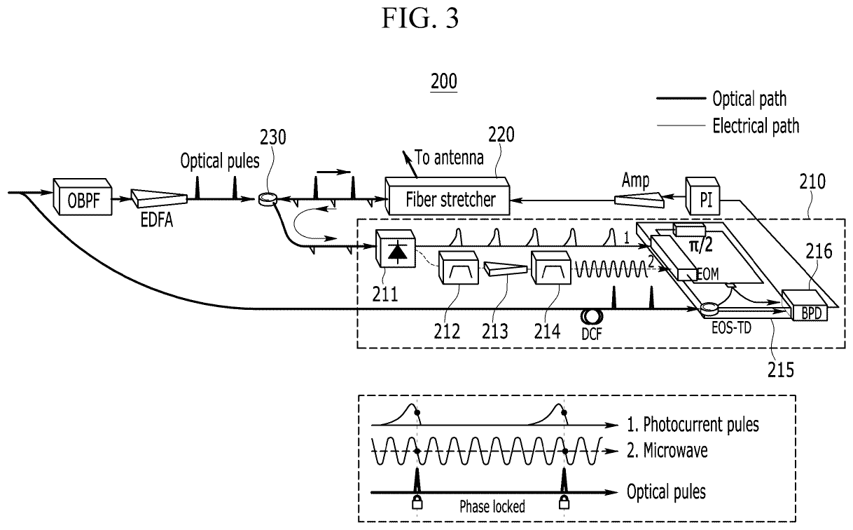

FIG. 3 shows a configuration of a fiber link stabilizer according to an embodiment.

Referring to FIG. 3, the fiber link stabilizer 200 including the EOS-TD-based timing detector 210 will now be described.

The optical pulse train output by the laser 120 may be divided into two streams, one stream may be used as the reference signal of the timing detector 210, and the other stream including a target optical pulse may be transmitted to the radio telescope through the optical fiber link. The target optical pulse may pass through an optical bandpass filter (OBPF) for controlling the width of the optical spectrum and may alleviate optical link dispersion. An erbium-doped fiber amplifier (EDFA) may be used to calibrate an OBPF insertion loss. A direct optical link dispersion compensation using dispersion compensating fibers may be used.

The target optical pulse may pass through the circulator 230 and the fiber stretcher 220, and may be transmitted to the antenna through the optical fiber link. The optical pulse reflected at the end of the optical fiber link may be transmitted to the timing detector 210 by the circulator 230.

The reflected optical pulse may be photoelectrically converted into a photocurrent pulse by the photodetector 211. The photocurrent pulse may be input to the EOS-TD 215, or the microwave signal extracted from the photocurrent pulse may be input to the EOS-TD 215. The microwave signal may be generated while the photocurrent pulse passes through the BPF 212, the amplifier 213, and the BPF 214.

The EOS-TD 215 may receive the photocurrent pulse/microwave signal photoelectrically converted the reference optical pulse output by the laser 120 and the reflected optical pulse.

The EOS-TD 215 may be implemented using a Sagnac loop interferometer, and may convert the timing difference between the optical pulse and the electric signal (or photocurrent pulse/microwave signal) into an intensity difference between the two signals through an interference phenomenon.

A balanced photodetector (BPD) 216 may sense an output of the EOS-TD 215 through a photodiode, and may output an electric signal (or a voltage) in proportion to the timing difference between the optical pulse and the electric signal.

The reference optical pulse may be adjusted to be disposed at an edge of the photocurrent pulse with a relative jitter on an attosecond level. In another way, the reference optical pulse may be adjusted to be disposed at a zero crossing of the microwave signal. The phase of the photocurrent pulse or the microwave signal is affixed to the optical pulse so the change of the optical fiber lengths or the change of timing may generate the relative timing difference without PLL, and this may be sensed from the output of the EOS-TD 215. The timing difference may be transmitted to the fiber stretcher 220 through a proportional-integral (PI) controller and a high-gain voltage amplifier to stabilize the timing of the optical fiber link.

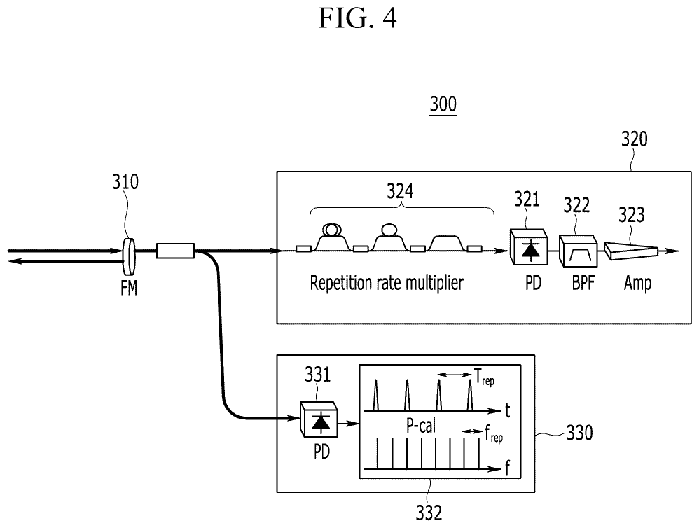

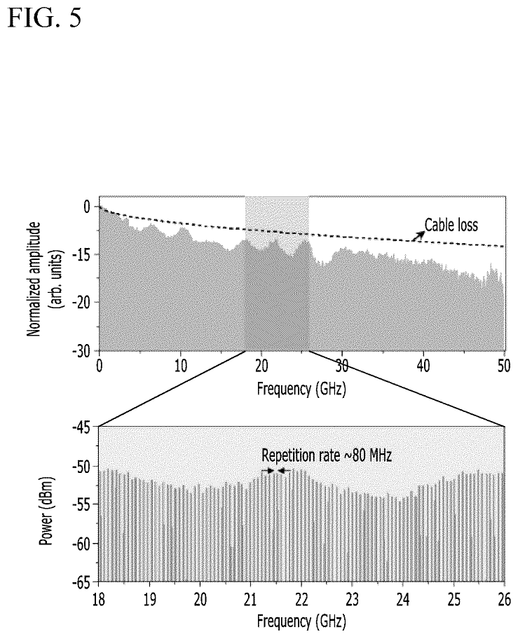

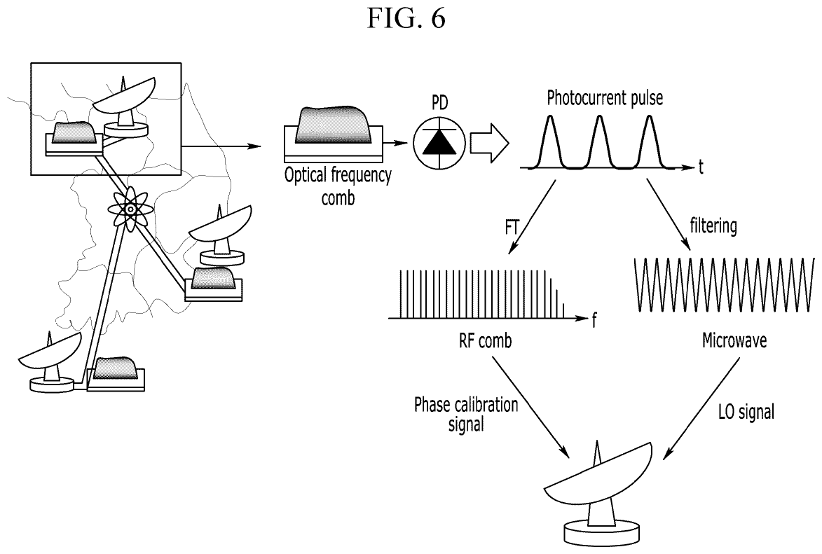

FIG. 4 shows a configuration of a signal generator according to an embodiment, FIG. 5 shows an example of a generated instrumental phase calibration signal according to an embodiment, and FIG. 6 conceptually shows generation of an optical frequency comb-based signal for a radio telescope according to an embodiment.

Referring to FIG. 4, the signal generator 300 installed in the radio telescope may generate a LO signal and an instrumental phase calibration signal (or PCal signal) through the optical frequency comb directly transmitted through the optical fiber link.

The LO signal extractor 320 may detect the optical pulse train transmitted through the optical fiber link by using the high-speed photodetector (PD) 321, and may generate a low-noise photocurrent pulse train that corresponds to the RF comb. The LO signal extractor 320 may detect the RF comb including integer multiple components with a repetition rate from the photocurrent pulse train, may filter the single frequency component with the band pass filter (BPF) 322, and may amplify the same with an amplifier 323 to generate the microwave signal in the GHz bandwidth. The LO signal extractor may further include an optical fiber-based repetition rate multiplier 324. The microwave signal may be used as the LO signal of the radio telescope.

The RF comb generator 330 may detect the optical pulse train transmitted through the optical fiber link by using the high-speed photodetector (PD) 331, and may generate a low-noise photocurrent pulse train. The photocurrent pulse train corresponds to the RF comb including integer multiple components with a repetition rate in the frequency domain so the RF comb generator 330 may use the RF comb obtained by performing a Fourier transform (FT) 332 on the photocurrent pulse train as the instrumental phase calibration signal (or PCal signal).

Referring to FIG. 5, the instrumental phase calibration signal (or PCal signal) may be generated from the optical frequency comb with the repetition rate of 80 MHz. The upper graph shows generation of PCal signals with the maximum frequency of 50 GHz displayed with the normalized amplitude, and the lower graph shows electric power spectrum of PCal signals in the K-band.

Referring to FIG. 6, to measure time delays of the RF signals reaching at least two antennas, the VLBI obtains the time delays by down-converting the RF signal by a very stable local oscillator, and phase calibration between channel devices inevitably generated by multi-channel concurrent observation is needed.

The signal generator 300 may directly receive the optical frequency comb stabilized to the frequency reference through the optical fiber link so the photocurrent pulse may be generated by photodetection of the optical frequency comb, and by this, the microwave used as the LO signal and the RF comb for calibrating the instrumental phase may be extracted.

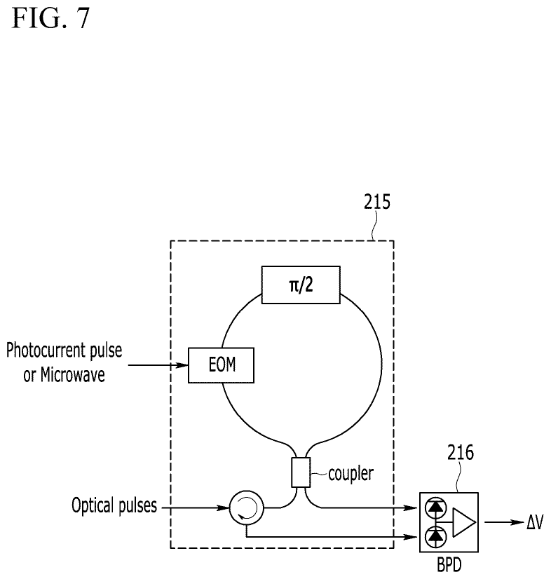

FIG. 7 shows an example of a timing detector according to an embodiment.

Referring to FIG. 7, the fiber link stabilizer 200 may detect optical fiber noise through various timing detectors, and for example, it may be implemented with an EOS-TD-based timing detector.

The EOS-TD 215 may receive the electric signal (or photocurrent pulse/microwave signal) photoelectrically converted from the reference optical pulse output by the laser 120 and the reflected optical pulse.

The EOS-TD 215 may be implemented using a Sagnac loop interferometer. The Sagnac loop interferometer may include a circulator, a coupler implemented on the loop, an electro-optic phase modulator (EOM), and a quarter-wave (π/2) bias unit.

The reference optical pulse may pass through the circulator and may reach the coupler. The coupler may divide power of the optical pulse into two optical pulses, and may transmit them in different directions of the loop.

When an electric signal (photocurrent pulse or microwave signal) is applied, the electro-optic phase modulator (EOM) may modulate the phase of the pulse circulating in a first direction according to an instantaneous voltage of the applied signal. The pulse circulating in the first direction and the pulse circulating in the second direction may pass through the quarter-wave (π/2) bias unit to generate the phase difference of π/2. The pulses having generated the phase difference while circulating the loops in different directions are combined by the coupler, and in this instance, the pulses having circulated in different directions generate interference with each other. The coupler separates the combined optical signal, and the two separated interference signals are output to two output ports of the loop interferometer. The two separated optical signals are input to the balanced photodetector (BPD) 216.

An intensity difference of the two optical signals input to the balanced photodetector (BPD) 216 is proportional to a timing error of the reference optical pulse and the electric signal input to the EOS-TD 215. The balanced photodetector (BPD) 216 may convert the intensity difference of the optical signals input to the two photodiodes into an electric signal (ΔV) through two photodiodes and a transimpedance amplifier.

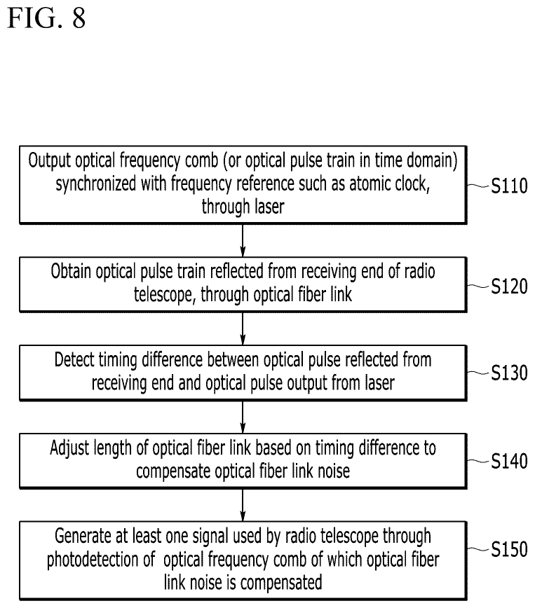

FIG. 8 shows a flowchart on a method for generating signals for a radio telescope according to an embodiment.

Referring to FIG. 8, the system 1 for generating signals for a radio telescope may output an optical frequency comb (or an optical pulse train in the time domain) synchronized with the frequency reference 110 such as an atomic clock, through the laser 120 (S110). The laser 120 of the system 1 may output the optical frequency comb synchronized with the frequency reference 110 and following stability of the frequency reference 110 by using the timing difference (or phase difference) with the frequency reference 110 transmitted from the timing detector 130.

The system 1 may obtain the optical pulse train reflected from the receiving end of the radio telescope, through the optical fiber link (S120). The optic fiber link is configured to for transmit the optical frequency comb to the receiving end from the transmitting end.

The system 1 may detect the timing difference between the optical pulse reflected from the receiving end and the optical pulse output from the laser 120 (S130).

The system 1 may adjust the length of the optical fiber link based on the timing difference to compensate optical fiber link noise (S140). The system 1 may adjust the length of the optical fiber link using the fiber length adjuster disposed on the optical fiber link.

The system 1 may generate at least one signal used by the radio telescope through photodetection of the optical frequency comb of which optical fiber link noise is compensated (S150). The signal used in the radio telescope may include an LO signal input to the local oscillator performing radio signal down-conversion, and an instrumental phase calibration signal (PCal signal). The LO signal may be a microwave signal in the GHz bandwidth, and the system 1 may generate a photocurrent pulse train through photodetection of the optical frequency comb, and may generate a microwave signal in the GHz bandwidth by filtering the single frequency component of the photocurrent pulse train. The system 1 may generate a photocurrent pulse train through photodetection of the optical frequency comb, and may use the photocurrent pulse train, corresponding to the RF comb, as the PCal signal.

According to the embodiment, the optical frequency comb for connecting the optical frequency domain and the microwave frequency domain may be directly transmitted to the remote radio telescope, and by using this, the low-noise local oscillator signal and the instrumental phase calibration signal required for observation may be easily generated.

According to the embodiment, the stability of the atomic clock may be transferred remotely using the optical frequency comb, allowing the very long baseline interferometer (VLBI) to fully utilize the stability of the atomic clock.

According to the embodiment, high correlation efficiency may be achieved by using the stabilized system to the atomic clock, enabling the high sensitivity radio interferometer observations minimizing the loss in the radio frequency bandwidth.

According to the embodiment, instrumental phase calibration signals in the tens of GHz band, which were challenging to generate with conventional electronic technology, can be provided using photon technology, maximizing the effect of atmospheric phase calibration through multi-channel simultaneous observation.

According to the embodiment, it is possible to calculate high-precision time delay from the VLBI based on the radio frequency bandwidth of several tens GHz and the wideband of up to 100 GHz, thereby improving the precision of the international celestial reference frame (ICRF), the international terrestrial reference frame (ITRF), and the earth orientation parameter (EOP), which have been implemented in the existing low frequency bandwidth of 10 GHz or less, and it may also contribute to improving determination of the precise position of the deep space probe and the navigation precision using the delta differential one-way ranging (ΔDOR) technology.

The embodiments are not only implemented through the device and/or the method described so far, but may also be implemented through a program that realizes the function corresponding to the configuration of the embodiment or a recording medium on which the program is recorded.

While this disclosure has been described in connection with what is presently considered to be practical exemplary embodiments, it is to be understood that the disclosure is not limited to the disclosed embodiments, but, on the contrary, is intended to cover various modifications and equivalent arrangements included within the spirit and scope of the appended claims.

What is claimed is:

1. A system comprising:
a laser configured to output an optical frequency comb synchronized with a frequency reference;
an optical fiber link configured to transmit the optical frequency comb to a receiving end of a radio telescope;
a fiber link stabilizer configured to detect a timing difference between an optical pulse reflected from the receiving end and an optical pulse output from the laser, and adjust a length of the optical fiber link based on the timing difference to compensate optical fiber link noise; and
a signal generator configured to generate at least one signal used by the radio telescope through photodetection of an optical frequency comb received at the receiving end.

2. The system of claim 1, wherein the signal generator is configured to:
generate a photocurrent pulse train through photodetection of the received optical frequency comb; and
generate a microwave signal for a local oscillator by filtering a single frequency component of the photocurrent pulse train.

3. The system of claim 1, wherein the signal generator is configured to:
generate a photocurrent pulse train through photodetection of the received optical frequency comb; and
output the photocurrent pulse train, corresponding to a radio-frequency (RF) comb, as a signal for phase calibration between channel devices of a multi-band receiver.

4. The system of claim 1, wherein an optical pulse train output from the laser is divided into a first stream and a second stream, and the first stream is input to the fiber link stabilizer and is used as a reference signal for detecting noise information of the optical fiber link, and the second stream is transmitted to the radio telescope through the optical fiber link.

5. The system of claim 1, wherein the fiber link stabilizer is configured to
transmit information on the timing difference to a fiber length adjuster disposed on the optical fiber link to compensate the timing difference.

6. The system of claim 1, wherein the fiber link stabilizer is configured to:
generate a photocurrent pulse through photodetection of the reflected optical pulse and detect the timing difference between the optical pulse output from the laser and the photocurrent pulse; or
generate a microwave signal from the photocurrent pulse and detect the timing difference between the optical pulse output from the laser and the microwave signal.

7. The system of claim 1, wherein the frequency reference includes an atomic clock, and
wherein the laser is configured to be synchronized with the frequency reference disposed on a local site, or be synchronized with the frequency reference disposed on a remote site by receiving a signal from the remote site.

8. A method for generating signals for a radio telescope by a system, comprising:
outputting an optical frequency comb synchronized with a frequency reference, through a laser;
obtaining an optical pulse reflected from a receiving end of the radio telescope through an optical fiber link, the optical fiber link configured to transmit the optical frequency comb to the receiving end from a transmitting end;
detecting a timing difference between an optical pulse reflected from the receiving end and an optical pulse output from the laser;
adjusting a length of the optical fiber link based on the timing difference to compensate optical fiber link noise; and
generating at least one signal used by the radio telescope through photodetection of the optical frequency comb received at the receiving end.

9. The method of claim 8, wherein the generating the at least one signal comprises:
generating a photocurrent pulse train through photodetection of the received optical frequency comb; and
generating a microwave signal for a local oscillator by filtering a single frequency component of the photocurrent pulse train.

10. The method of claim 8, wherein the generating the at least one signal comprises:
generating a photocurrent pulse train through photodetection of the received optical frequency comb; and
outputting the photocurrent pulse train, corresponding to a radio-frequency (RF) comb, as a signal for phase calibration between channel devices of a multi-band receiver.

11. The method of claim 8, wherein an optical pulse train output from the laser is divided into a first stream and a second stream, and the first stream is input to the fiber link stabilizer and is used as a reference signal for detecting noise information of the optical fiber link, and the second stream is transmitted to the radio telescope through the optical fiber link.

12. The method of claim 8, wherein the adjusting the length of the optical fiber link comprises
transmitting information on the timing difference to a fiber length adjuster disposed on the optical fiber link to compensate the timing difference.

13. The method of claim 8, wherein the detecting the timing difference comprises:
generating a photocurrent pulse through photodetection of the reflected optical pulse, and detecting the timing difference between the optical pulse output from the laser and the photocurrent pulse; or
generating a microwave signal from the photocurrent pulse, and detecting the timing difference between the optical pulse output from the laser and the microwave signal.

14. The method of claim 8, wherein the frequency reference includes an atomic clock, and
wherein the laser is configured to be synchronized with the frequency reference disposed on a local site, or be synchronized with the frequency reference disposed on a remote site by receiving a signal from the remote site.

15. A system comprising:
a laser configured to output an optical pulse train synchronized with a frequency reference;
an optical fiber link configured to transmit a first optical pulse train to a receiving end of a radio telescope, the first optical pulse train being divided from the optical pulse train output from the laser;
a fiber length adjuster configured to adjust a length of the optical fiber link according to an input, disposed on the optical fiber link;
a fiber link stabilizer configured to detect a timing difference between a second optical pulse train and an optical pulse train reflected from the receiving end, and compensate optical fiber link noise of the first optical pulse train by transmitting information on the timing difference to the fiber length adjuster, the second optical pulse train being divided from the optical pulse train output from the laser; and
a signal generator configured to generate at least one signal used by the radio telescope through photodetection of the first optical pulse train at the receiving end.

16. The system of claim 15, wherein the signal generator includes:
a photodetector configured to generate a photocurrent pulse train through photoelectric conversion of the first optical pulse train, and
a band pass filter configured to output a microwave signal by filtering a single frequency component of the photocurrent pulse train, and
wherein the microwave signal is used as a signal for a local oscillator.

17. The system of claim 15, wherein the signal generator includes a photodetector configured to generate a photocurrent pulse train through photoelectric conversion of the first optical pulse train, and
wherein the photocurrent pulse train, corresponding to a radio-frequency (RF) comb, is used as a signal for phase calibrating between channel devices of a multi-band receiver.

18. The system of claim 16, wherein the fiber link stabilizer includes:
a photodetector configured to output a photocurrent pulse train through photoelectric conversion of the reflected optical pulse train; and
an electro-optic sampling-based timing detector (EOS-TD) configured to detect the timing difference between the second optical pulse train and the photocurrent pulse train.

19. The system of claim 16, wherein the fiber link stabilizer is configured to:
generate a photocurrent pulse through photodetection of the reflected optical pulse;
generate a microwave signal from the photocurrent pulse through a band pass filter; and
detect the timing difference between the second optical pulse train and the microwave signal through an electro-optic sampling-based timing detector (EOS-TD).

20. The system of claim 15, wherein the laser is configured to output an optical frequency comb following stability of the frequency reference by being synchronized with the frequency reference disposed on a local site, or being synchronized with the frequency reference disposed on a remote site by receiving a signal from the remote site.
